(19) United States
(12) Patent Application Publication
(10) Pub. No.: US 2011/0220245 A1
(43) Pub. Date: Sep. 15, 2011

(54) METHOD OF MANUFACTURING COMPRESSED WOOD PRODUCT

(75) Inventor: Tatsuya SUZUKI, Tokyo (JP)

(73) Assignee: OLYMPUS CORPORATION, Tokyo (JP)

(21) Appl. No.: 13/036,666

(22) Filed: Feb. 28, 2011

(30) Foreign Application Priority Data
Mar. 12, 2010 (JP) 2010-056328

(51) Int. Cl. B27M 1/08

(52) U.S. Cl. 144/360

(57) ABSTRACT

A method of manufacturing a compressed wood product includes cutting out a blank piece from raw wood, the blank piece having a shape in which a circularly closed marginal part makes a first plane, only one space of two spaces divided by the first plane has an undulation that includes a plurality of convex vertices, a vertex of which height from the first plane is higher is located at a position closer to a geometrical center of the circularly closed marginal part among arbitrary two vertices of the plurality of convex vertices when being viewed on a second plane that passes the two vertices and is perpendicular to the first plane, the blank piece having a volume obtained by adding an amount by which a volume of the blank piece is decreased by compression; softening the blank piece cut out; and compressing the softened blank piece in a water-vapor atmosphere having temperature and pressure higher than those of atmospheric air to deform the blank piece into a shape substantially like a bowl.

### CROSS-REFERENCE TO RELATED APPLICATION

This application is based upon and claims the benefit of priority from Japanese Patent Application No. 2010-056328, filed on Mar. 12, 2010, the entire contents of which are incorporated herein by reference.

### BACKGROUND OF THE INVENTION

1. Field of the Invention

The present invention relates to a method of manufacturing a compressed wood product having a predetermined three-dimensional shape by compressing and forming a wooden piece.

2. Description of the Related Art

In recent years, wood which is a natural material attracts attention. With a wide variety of grain patterns, wood products exhibit individual features depending on positions of raw wood from which the particular wood products are cut out. In addition, surface flaws and discolorations caused by a long-term use create unique textures which tend to evoke warm and familiar feeling in the user. Thus, the wood attracts attention as a material for products of uniqueness and taste which cannot be found in products made of synthetic resin or light metals. Techniques for processing wood are also developing dramatically.

There is a technique for processing a wooden piece into a predetermined three-dimensional shape through compression as one of the processing techniques of wood described above. For example, there has been known a technique for temporarily fixing a wooden board that is compressed after a softening process, putting the wooden board in a metal mold to restore it, and shaping the wooden board into a three-dimensional shape (for example, see Japanese Laid-open Patent Publication No. 11-77619). In this technique, a softened wooden board is first compressed and temporarily fixed. After that, plate material obtained by slicing the temporarily fixed wooden board is set in a metal mold, and the plate material is again softened in high-pressure water vapor to perform a bending process. Next, a curved member on which the bending process is performed is again set in the metal mold to again soften the curved member, and then a final shape is obtained by pressing the member by using a pressing machine.

Moreover, as another technique for processing a wooden piece through compression, there has been known a technique for performing a vapor heating and pressurizing process on a wooden piece and then performing a heating and pressurizing process on the wooden piece as a second process in order to manufacture a wood piece that has improved dimensional stability by improving anti-swelling efficiency (ASE) (for example, see Japanese Patent No. 2855139). This technique discloses that a heating and pressurizing process is performed on a flat plate-like wooden piece to improve the dimensional stability of the wooden piece as an embodiment.

As an application example of the technique for processing a wooden piece through compression, there has also been known a technique by which an ornamental pattern for changing a grain pattern can be easily formed (for example, see Japanese Laid-open Patent Publication No. 2005-205618). This technique includes a process for taking the form of a substantially wooden bowl-shaped blank piece that has a curved face along concavity and convexity of a mold face of a metal mold for molding and a convex portion or a concave portion from which a grain pattern is exposed by protrusion or depression of the curved face and a process for processing the convex portion or the concave portion to be a smooth surface, which is smoothly connected to its vicinity. According to the technique as described in Japanese Laid-open Patent Publication No. 2005-205618, various grain patterns excellent in design that cannot be obtained in the conventional art can be achieved.

### SUMMARY OF THE INVENTION

A method of manufacturing a compressed wood product according to an aspect of the present invention includes cutting out a blank piece from raw wood, the blank piece having a shape in which a circularly closed marginal part makes a first plane, only one space of two spaces divided by the first plane has an undulation that includes a plurality of convex vertices, a vertex of which height from the first plane is higher is located at a position closer to a geometrical center of the circularly closed marginal part among arbitrary two vertices of the plurality of convex vertices when being viewed on a second plane that passes the two vertices and is perpendicular to the first plane, the blank piece having a volume obtained by adding an amount by which a volume of the blank piece is decreased by compression; softening the blank piece cut out; and compressing the softened blank piece in a water-vapor atmosphere having temperature and pressure higher than those of atmospheric air to deform the blank piece into a shape substantially like a bowl.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a flowchart illustrating the brief of a method of manufacturing a compressed wood product according to an embodiment of the present invention;

FIG. 2 is a diagram typically illustrating the brief of a blank piece cutting-out process in the method according to the embodiment;

FIG. 3 is a cross-sectional view (an A-A line cross-sectional view of FIG. 2) illustrating the configuration of a blank piece;

FIG. 4 is a diagram typically illustrating the brief of a compression process in the method according to the embodiment;

FIG. 5 is an A-A line cross-sectional view of FIG. 4;

FIG. 6 is a diagram illustrating a state where the deformation of the blank piece is substantially completed at the compression process in the method according to the embodiment;

FIG. 7 is a diagram typically illustrating the brief of a shaping process in the method according to the embodiment;

FIG. 8 is a diagram typically illustrating a state where a pair of shaping concave metal mold and shaping convex metal mold is fastened at the shaping process in the method according to the embodiment;

FIG. 9 is a perspective diagram illustrating the configuration of the blank piece after the shaping process in the method according to the embodiment;

FIG. 10 is a perspective diagram illustrating the configuration of an exterior body of a digital camera as an example of application of the compressed wood product manufactured by the method according to the embodiment; and

FIG. 11 is a perspective diagram illustrating the exterior configuration of a digital camera having the exterior body illustrated in FIG. 10 as a jacket.

### DETAILED DESCRIPTION OF THE PREFERRED EMBODIMENTS

Exemplary embodiments of the present invention will be explained in detail below with reference to the accompanying drawings. Moreover, the drawings to be referred to below are just schematic examples, and thus a size or a reduction scale may be different when the same part is illustrated in the different drawing.

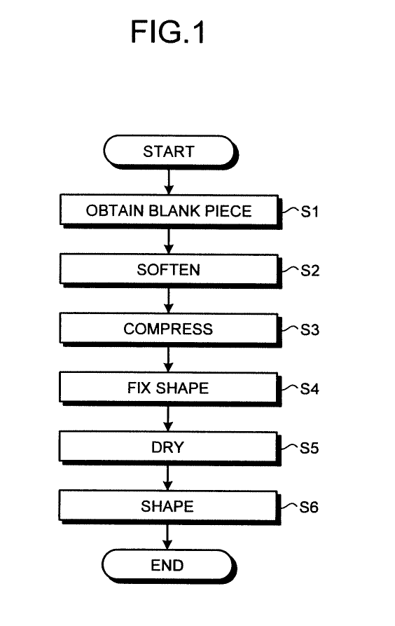

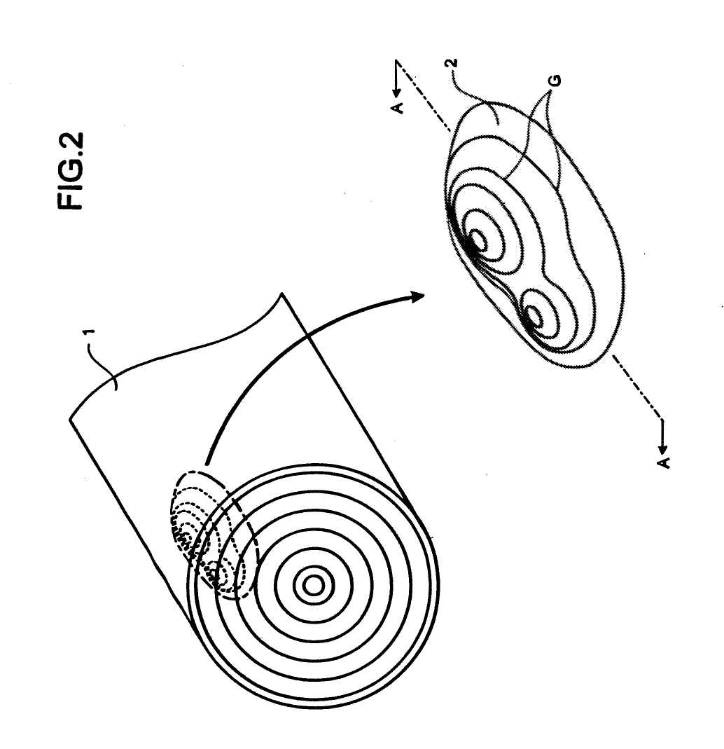

FIG. 1 is a flowchart illustrating the brief of a method of manufacturing a compressed wood product according to an embodiment of the present invention. First, a blank piece is formed by cutting out the blank piece having a shape as described below from raw wood (Step S1). FIG. 2 is a diagram typically illustrating the brief of a blank piece cutting-out process. In the blank piece cutting-out process, a blank piece 2 is taken by cutting or the like from raw wood 1 such as uncompressed solid wood.

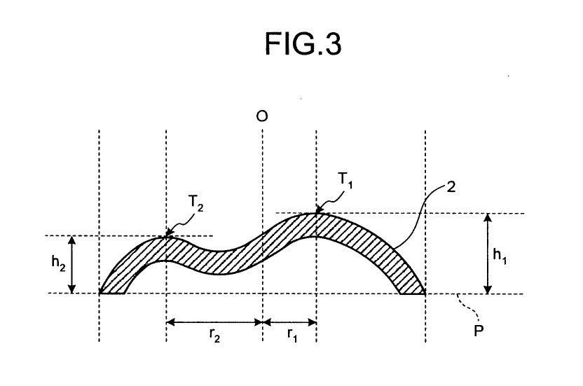

FIG. 3 is an A-A line cross-sectional view of the blank piece 2 illustrated in FIG. 2. In the blank piece 2, a circularly closed marginal part makes a plane P (first plane), and only one space (the upper space of the plane P in FIG. 3) of two spaces divided by the plane P has an undulation that includes a plurality of convex vertices T1 and T2. Moreover, when the blank piece 2 is viewed on a second plane (on the page space illustrated in FIG. 3) that passes the vertices Tₗ and T₂ and is perpendicular to the plane P, the vertex T₁ (height h₁) of which the height from the plane P is high is located at a position closer to a height-direction central axis “O” that is perpendicular to the plane P, compared to the vertex T₂ (height h₂) lower than the vertex T₁. Specifically, in FIG. 3, a distance r₁ between the vertex Tᵢ and the central axis “O” is smaller than a distance r₂ between the vertex T₂ and the central axis “O” (r₁<r₂). The blank piece 2 that is formed in this way has a substantially uniform wall thickness, has a volume obtained by adding an amount by which the volume of the blank piece is decreased by a compression process to be described below, and has a grain pattern G that continuously changes in a natural manner and is exposed to its surface (see FIG. 1). Moreover, it is preferable that the shape of the blank piece 2 be determined in consideration of various requirements such as the size and the shape change by manufacturing.

It is only necessary that the blank piece, which is formed at a blank piece cutting-out process in the method according to the present embodiment, more generally satisfy the next property. In other words, in the blank piece that is formed at the blank piece cutting-out process, it is only necessary that a circularly closed marginal part make the first plane, one space of two spaces divided by the first plane have an undulation that includes the plurality of convex vertices, the vertex of which the height from the first plane is higher be located at a position closer to a geometrical center of the circularly closed marginal part among arbitrary two vertices of the plurality of convex vertices when being viewed on the second plane that passes the two vertices and is perpendicular to the first plane, and the blank piece have a substantially uniform wall thickness. Therefore, the number of convex vertices of the blank piece may be, for example, three or more.

Next, the blank piece 2 is left in a water-vapor atmosphere having high temperature and pressure for a predetermined time to be softened (Step S2). In the water-vapor atmosphere, a pressure is around 0.1 to 0.8 MPa and a temperature is around 100 to 170° C. The water-vapor atmosphere is realized by using a pressure vessel. When using a pressure vessel, it is only necessary that the blank piece 2 be softened while left in the pressure vessel having the water-vapor atmosphere. Moreover, instead of softening the blank piece 2 in the water-vapor atmosphere having high temperature and pressure, the blank piece 2 may be softened by heating with microwaves after making the blank piece 2 absorb moisture. Moreover, the blank piece 2 may be softened by boiling.

After that, the softened blank piece 2 is compressed (Step S3). At this process, the blank piece 2 is sandwiched with a pair of metal molds to be applied with a compressive force in the same water-vapor atmosphere as that at the softening process, and thus the blank piece 2 is deformed into a predetermined three-dimensional shape. When the blank piece 2 is softened in a pressure vessel, it is only necessary to continuously compress the blank piece 2 in the pressure vessel.

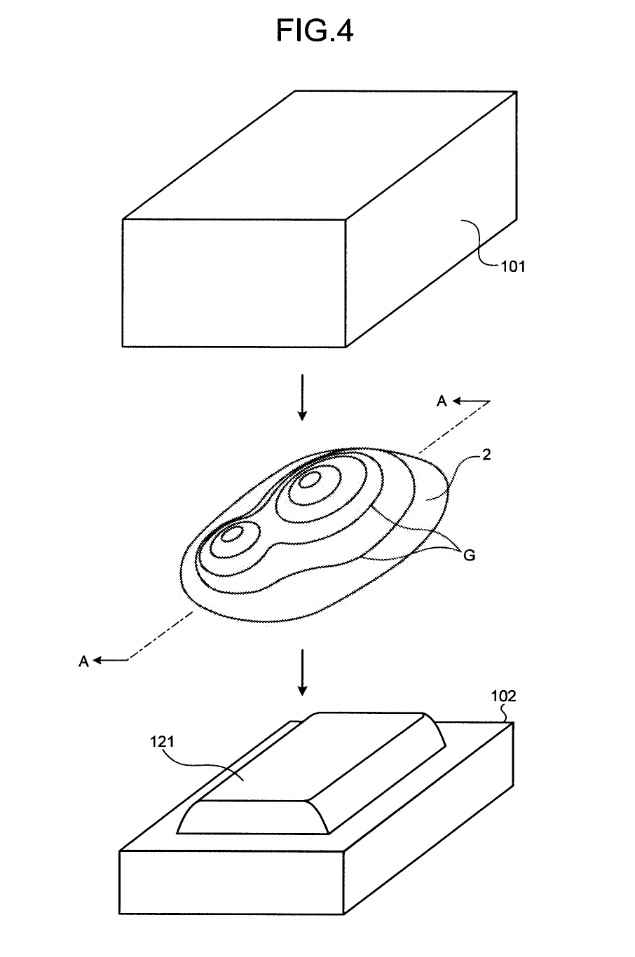

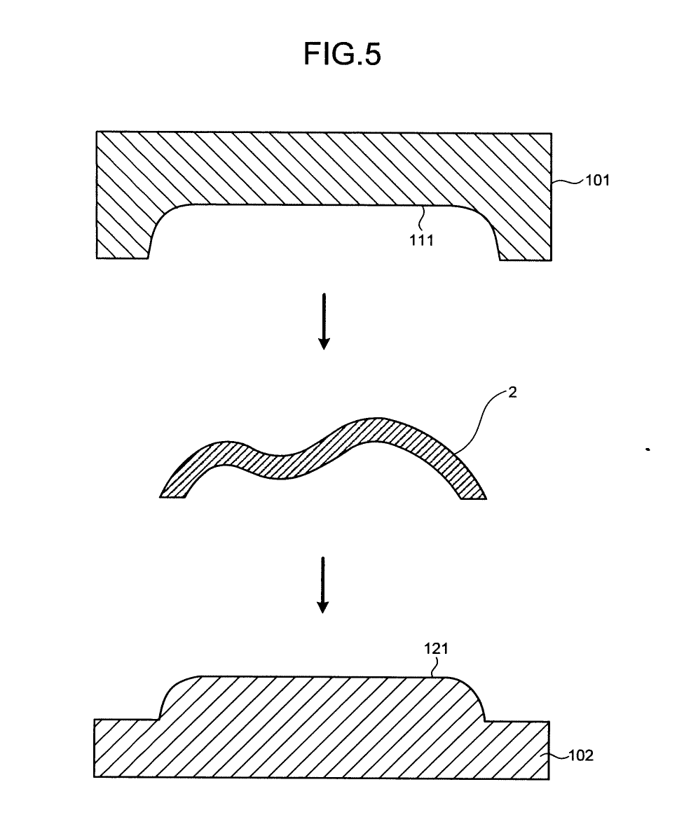

FIG. 4 is a diagram illustrating the brief of the compression process and the substantial configuration of metal molds that are used at the compression process. FIG. 5 is an A-A line cross-sectional view of FIG. 4. As illustrated in FIGS. 4 and 5, the blank piece 2 is sandwiched by a pair of concave metal mold 101 and convex metal mold 102 to be applied with a predetermined compressive force.

The concave metal mold 101, which applies a compressive force from the upper side of the blank piece 2 in the case of the compression process, includes a concave portion 111 that has a smooth surface that comes into contact with the protruding outer surface of the blank piece 2. On the other hand, the convex metal mold 102, which applies the compressive force from the lower side of the blank piece 2 in the case of the compression process, includes a convex portion 121 that has a smooth surface that comes into contact with the recessed inner surface of the blank piece 2. A lower end surface and an upper end surface form a plane, in which the lower end surface is located at the outer circumference of the concave portion 111 of the concave metal mold 101 and the upper end surface is located at the outer circumference of the convex portion 121 of the convex metal mold 102. In a state where the concave metal mold 101 and the convex metal mold 102 are fastened, the lower end surface of the concave portion 111 and the upper end surface of the convex portion 121 are overlapped. The shape of a gap between the concave portion 111 and the convex portion 121 in the fastened state corresponds to the shape of the blank piece 2 after the compression process.

A slope of an inside inclined plane of the concave portion 111 to the lower end surface of the concave metal mold 101 is steeper than a slope of the blank piece 2 to the plane P near its marginal part. Similarly, a slope of an outside inclined plane of the convex portion 121 to the upper end surface of the convex metal mold 102 is steeper than a slope of the blank piece 2 to the plane P near its marginal part. In this way, according to the present embodiment, the blank piece 2 before compression has a shape different from that of the metal molds for compression.

At the compression process, the blank piece 2 is mounted on the convex portion 121 and contacts with the concave portion 111 from the upper side. At that time, because the vertex (T1) of which the height is the higher is located at the position the closer to the center of the circularly closed marginal part when being viewed from the plane P made by the marginal part in the blank piece 2, the vertices come into contact with the concave portion 111 in sequence from the highest vertex. Therefore, during making the concave metal mold 101 approach the convex metal mold 102, the blank piece 2 does not lean on the convex portion 121. As a result, even if the blank piece 2 having a shape very different from that of the concave portion 111 and the convex portion 121 is used, the blank piece 2 can be surely compressed.

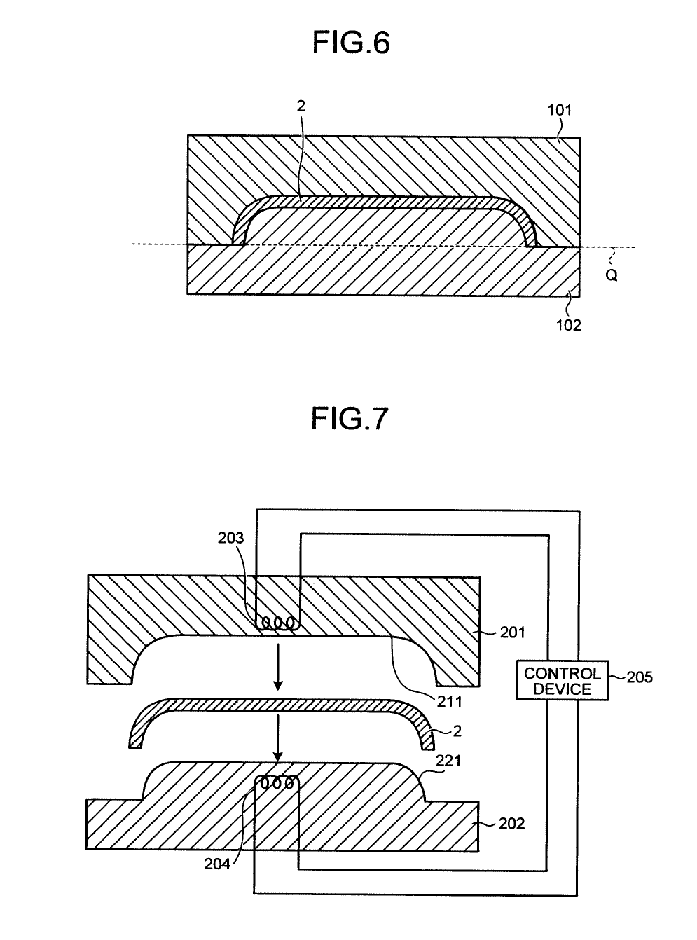

FIG. 6 is a diagram illustrating a state where the blank piece 2 is sandwiched by the concave metal mold 101 and the convex metal mold 102 to apply a predetermined pressure at the compression process and the deformation of the blank piece 2 is substantially completed. In the state illustrated in FIG. 6, the blank piece 2 receives the compressive force from the concave metal mold 101 and the convex metal mold 102 to be deformed into a predetermined three-dimensional shape. “The predetermined three-dimensional shape” is a shape that corresponds to a gap formed by the concave portion 111 and the convex portion 121 in a state where the concave metal mold 101 is closest to the convex metal mold 102. The three-dimensional shape forms a shape substantially similar to a final shape that is obtained through a shaping process (Step S6) to be described below and has a volume larger than that of the final shape.

However, in FIG. 6, a plane Q obtained by overlapping the lower end surface of the concave metal mold 101 and the upper end surface of the convex metal mold 102 passes the marginal part of the blank piece 2 that has a shape substantially like a bowl. In the sense, similarly to the plane P, the plane Q is the first plane. A slope of the blank piece 2 after the compression process to the plane Q near its marginal part is steeper than a slope of the blank piece 2 before the compression process to the plane P near its marginal part. In other words, the maximum value of an inclination angle of the blank piece 2 after the compression process to the plane Q near its marginal part is larger than the maximum value of an inclination angle of the blank piece 2 before the compression process to the plane P near its marginal part. In this way, according to the present embodiment, because the shapes of the blank piece 2 before and after the compression are largely different, continuously changing grain patterns are easily generated.

After the compression process is terminated, the blank piece 2 is sandwiched by the concave metal mold 101 and the convex metal mold 102, and the shape of the blank piece 2 is fixed by forming a water-vapor atmosphere having much higher temperature and pressure than the water-vapor atmosphere described above around the concave metal mold 101 and the convex metal mold 102 in a state where the blank piece 2 is maintained into the predetermined three-dimensional shape (Step S4). In the water-vapor atmosphere at this time, a pressure is around 0.7 to 3.4 MPa and a temperature is around 160 to 240° C. When performing the fixing processes in the pressure vessel, it is only necessary to set the internal pressure of the vessel at the softening process to a value within the range described above.

Next, the concave metal mold 101, the convex metal mold 102, and the blank piece 2 are exposed to the atmospheric air to dry the blank piece 2 (Step S5). In this case, the concave metal mold 101 and the convex metal mold 102 may be separated to accelerate the drying of the blank piece 2.

It is preferable that the wall thickness of the blank piece 2 after the drying process be around 20 to 50% of the thickness of the blank piece 2 before the compression process. In this case, the thickness of the blank piece 2 may have some amount of fluctuation. Therefore, according to the present embodiment, it is desirable that the minimum value of the wall thicknesses of the blank piece 2 be set to become not less than the wall thickness of a final shape that is shaped by the shaping process to be described below.

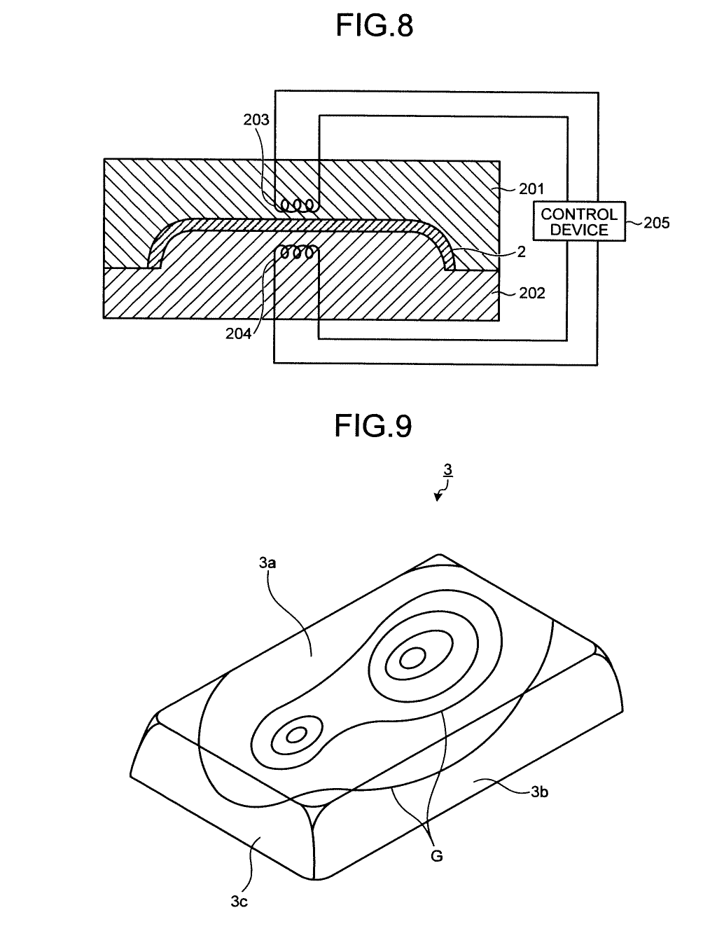

After the drying process, the blank piece 2 is shaped into a final shape while applying heat to the blank piece 2 in the atmospheric air (Step S6). FIG. 7 is a diagram typically illustrating the brief of the shaping process. At the shaping process, the blank piece 2 is shaped into the final shape while being heated by sandwiching the blank piece 2 by using a pair of shaping concave metal mold 201 and shaping convex metal mold 202. FIG. 8 is a diagram typically illustrating a state where the pair of shaping concave metal mold and shaping convex metal mold is fastened at the shaping process.

The shaping concave metal mold 201, which is located on the upper side of the blank piece 2 in FIG. 7, includes a concave portion 211 that has a smooth surface that comes into contact with the protruding surface of the blank piece 2. On the other hand, the shaping convex metal mold 202, which is located on the lower side of the blank piece 2 in FIG. 7, includes a convex portion 221 that has a smooth surface that comes into contact with the recessed surface of the blank piece 2. A lower end surface and an upper end surface forms a plane, in which the lower end surface is located at the outer circumference of the concave portion 211 of the shaping concave metal mold 201 and the upper end surface is located at the outer circumference of the convex portion 221 of the shaping convex metal mold 202. As illustrated in FIG. 8, in a state where the shaping concave metal mold 201 and the shaping convex metal mold 202 are fastened, the lower end surface of the concave portion 211 and the upper end surface of the convex portion 221 are overlapped. The shape of a gap between the concave portion 211 and the convex portion 221 in the fastened state corresponds to a shape substantially like a bowl that is the final shape of the blank piece 2. A volume of the final shape is smaller than a volume of the blank piece 2 after the compression process by an amount by which the volume of the blank piece is decreased at the shaping process.

The shaping concave metal mold 201 and the shaping convex metal mold 202 respectively include therein heaters 203 and 204 that generate heat. The heaters 203 and 204 are connected to a control device 205 that has a temperature control function, and generate heat under the control of the control device 205 to apply the generated heat to the shaping concave metal mold 201 and the shaping convex metal mold 202. The control device 205 controls the temperature of metal molds in such a manner that the temperature of metal molds when the blank piece 2 is sandwiched is not less than a temperature at which the non-crystallized region of a woody part is crystallized and is not more than a thermal decomposition temperature of the woody part.

When the control device 205 controls the temperature of metal molds in this way, a surface hardness of the woody part increases because the density of the woody part becomes remarkably high in accordance with the advance of the crystallization of the woody part in the middle of the shaping process. As a result, a compressed wood product that is not subject to moisture absorption and is excellent in morphological stability can be obtained.

Moreover, substances included inside a cell wall of the woody part are extracted onto the surface of the blank piece 2 by shaping it in the atmospheric air, and thus a color and luster occur on the surface. As a result, this can bring about a unique texture of only the wooden piece.

Moreover, if a shaping board is provided on the outside surface of the blank piece 2 that faces the concave portion 211, a tensile force acting on the outside surface of the blank piece 2 at the shaping process can be suppressed as much as possible. Therefore, the breaking or the like of the surface of the blank piece 2 at the shaping process can be prevented surely and remarkably.

FIG. 9 is a perspective diagram illustrating the configuration of a blank piece (hereinafter, “compressed wood product 3”) that is obtained by performing the shaping process. The compressed wood product 3 illustrated in FIG. 9 includes a main plate portion 3a that is flat plate-shaped and has a substantially rectangular surface, two side plate portions 3b that curve and extend from each of two facing long sides to the main plate portion 3a on the surface of the main plate portion 3a, and two side plate portions 3c that curve and extend from each of two facing short sides to the main plate portion 3a on the surface of the main plate portion 3a.

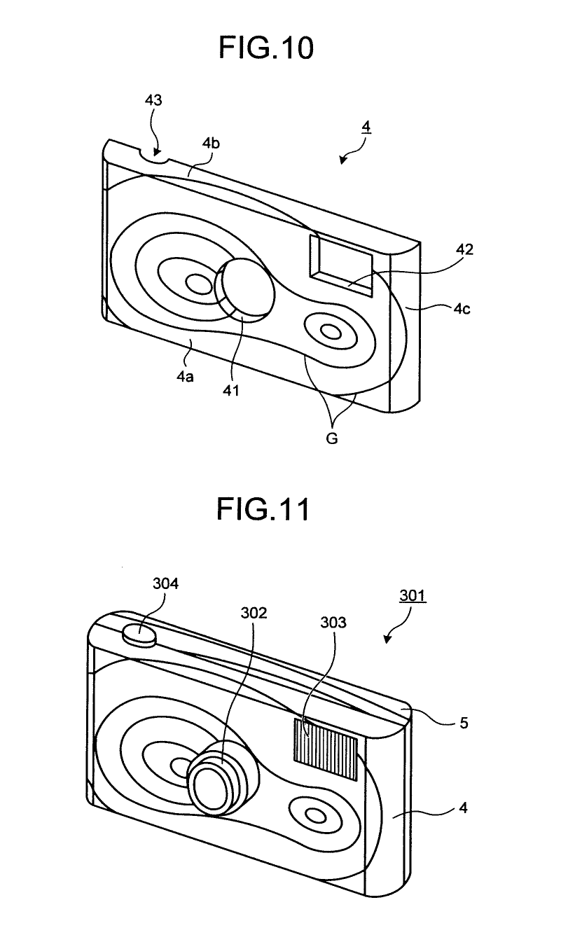

FIG. 10 is a perspective diagram illustrating the configuration of an exterior body 4 of a digital camera as an example of application of the compressed wood product manufactured by the method of manufacturing a compressed wood product as described above. The exterior body 4 illustrated in FIG. 10 is a component with which the front side (the side facing a subject) of the digital camera is covered. The exterior body 4 includes a main plate portion 4a and side plate portions 4b and 4c that respectively correspond to the main plate portion 3a and the side plate portions 3b and 3c of the compressed wood product 3. The main plate portion 4a includes a cylindrical opening 41 from which an imaging unit of the digital camera is exposed and a rectangular opening 42 from which a flash of the digital camera is exposed. The side plate portion 4b has a semi-cylindrical notch 43 from which a shutter button is protruded.

FIG. 11 is a perspective diagram illustrating the exterior configuration of a digital camera 301 of which the front side is covered with the exterior body 4. The digital camera 301 illustrated in FIG. 11 includes an imaging unit 302, a flash 303, and a shutter button 304. The front side of the digital camera 301 from which the imaging unit 302 and the flash 303 are exposed is covered with the exterior body 4. On the other hand, the rear side of the digital camera 301 is covered with an exterior body 5 that is formed of the compressed wood product 3 similarly to the exterior body 4. In this way, when the compressed wood product manufactured by the method according to the present embodiment is applied as an exterior body of a digital camera, it is preferable that its wall thickness be around 1.6 to 2.0 mm.

According to the embodiment of the present invention described above, a circularly closed marginal part makes the first plane, only one space of two spaces divided by the first plane has an undulation that includes the plurality of convex vertices, the vertex of which the height from the first plane is higher is located at a position closer to a geometrical center of the circularly closed marginal part among arbitrary two vertices of the plurality of convex vertices when being viewed on the second plane that passes the two vertices and is perpendicular to the first plane, a blank piece forming a shape having a volume obtained by adding an amount by which the volume of the blank piece is decreased by compression is formed, and the blank piece is compressed. Therefore, grain patterns continuously changing in a natural manner can be generated.

The compressed wood product manufactured by the method according to the present invention can be applied to an exterior body for electronics other than a digital camera. Moreover, the compressed wood product manufactured by the method according to the present invention can be applied to, for example, tableware, various types of cases, building material, and the like.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of manufacturing a compressed wood product, the method comprising:
cutting out a blank piece from raw wood, the blank piece having a shape in which a circularly closed marginal part makes a first plane, only one space of two spaces divided by the first plane has an undulation that includes a plurality of convex vertices, a vertex of which height from the first plane is higher is located at a position closer to a geometrical center of the circularly closed marginal part among arbitrary two vertices of the plurality of convex vertices when being viewed on a second plane that passes the two vertices and is perpendicular to the first plane, the blank piece having a volume obtained by adding an amount by which a volume of the blank piece is decreased by compression;
softening the blank piece cut out; and
compressing the softened blank piece in a water-vapor atmosphere having temperature and pressure higher than those of atmospheric air to deform the blank piece into a shape substantially like a bowl.

2. The method according to claim 1, wherein a slope of the blank piece to the first plane near the marginal part is steeper after the compressing than before the compression.

3. The method according to claim 2, wherein the compressing includes sandwiching the blank piece by using a pair of metal molds to apply a compressive force.

4. The method according to claim 3, further comprising placing the compressed blank piece in a water-vapor atmosphere having temperature and pressure much higher than those of the water-vapor atmosphere in a state where the compressed blank piece is sandwiched by the pair of metal molds in order to fix a shape of the blank piece after the compressing.

5. The method according to claim 1, wherein the compressing includes sandwiching the blank piece by using a pair of metal molds to apply a compressive force.

6. The method according to claim 5, further comprising placing the compressed blank piece in a water-vapor atmosphere having temperature and pressure much higher than those of the water-vapor atmosphere in a state where the compressed blank piece is sandwiched by the pair of metal molds in order to fix a shape of the blank piece after the compressing.
